(19) United States
(12) Patent Application Publication
(10) Pub. No.: US 2012/0086350 A1
(43) Pub. Date: Apr. 12, 2012

(54) FULL-BRIDGE ELECTRONIC BALLAST HAVING SIMPLIFIED CONTINUOUS-CONDUCTION-MODE CHARGE PUMP PFC CIRCUIT

(75) Inventors: Ray-Lee Lin, Tainan (TW); Jung-Wei Chang, Tainan (TW)

(73) Assignee: NATIONAL CHENG KUNG UNIVERSITY, Tainan (TW)

(21) Appl. No.: 13/271,714

(22) Filed: Oct. 12, 2011

(30) Foreign Application Priority Data
Oct. 12, 2010 (TW) 99134807
Oct. 12, 2010 (TW) 99134808
Oct. 12, 2010 (TW) 99134809
Oct. 12, 2010 (TW) 99134810
Oct. 12, 2010 (TW) 99134813
Oct. 12, 2010 (TW) 99134816

(51) Int. Cl. H05B 37/02

(52) U.S. Cl. 315/200 R

(57) ABSTRACT

The configurations of an electronic ballast are provided in the present invention. The proposed electronic ballast includes a filter circuit having a first and a second output terminals, a rectifier circuit having a first input terminal, a second input terminal coupled to the second output terminal of the filter circuit, and a first output terminal, and a continuous-conduction-mode charge pump PFC circuit including a first inductor having a first terminal coupled to the first input terminal and a second terminal coupled to the first output terminal of the filter circuit, a second inductor having a first terminal and a first capacitor having a first terminal coupled to the first terminal of the first inductor and a second terminal coupled to the first terminal of the second inductor.

### FIELD OF THE INVENTION

The application claims the benefit of Taiwan Patent Application Nos. 099134807-099134810, 099134813 and 099134816, filed on Oct. 12, 2010, in the Taiwan Intellectual Property Office, the disclosures of which are incorporated herein in their entirety by reference.

The present invention relates to a full-bridge electronic ballast having a continuous-conduction-mode charge pump power factor correction (PFC) circuit. More particularly, it relates to a full-bridge electronic ballast having a simplified voltage-source (or current-source) continuous-conduction-mode charge pump PFC circuit.

### BACKGROUND OF THE INVENTION

Following the progress of the illumination techniques, the electromagnetic ballasts are gradually replaced by the electronic ballasts to be applied to the illumination market. Comparing with the electromagnetic ballasts, the electronic ballasts have the advantages of small size, light weight, less flicker and longer lifetime and possess the competition power while they are applied to the illumination market so that the electronic ballasts have an extremely large development potential. In order to meet the IEC 61000-3-2 Class C regulation for the input current, the electronic ballasts having the PFC functions have been employed in the illumination apparatuses generally. Currently, the two-stage electronic ballasts having the PFC functions (as shown in FIG. 1) are the main-stream, and the two-stage electronic ballast comprises an AC input power source (supplying an AC input voltage Vin), a filter circuit (comprising an inductor L_{EMI} and a capacitor C_{EMI}), a rectifier circuit (comprising four diodes D_{br1}-D_{br4}), a PFC stage (comprising an inductor L_{pfc}, a diode D_{y} and a switch S_{pfc}) and a full-bridge inverter (comprising an inductor Lₛ, two capacitors C_{B} and Cₚ, four switches S1-S4 and a lamp) with the drawbacks of:

(1) requiring more elements, thus to have the relatively higher costs of the electronic circuit,

(2) requiring control ICs in both the PFC circuit and the power stage, thus to have the relatively complex circuit.

To solve the above-mentioned drawbacks, a half-bridge electronic ballast having a discontinuous-conduction-mode (DCM) charge-pump (CP) PFC circuit (as shown in FIG. 2) has been developed. Except for the AC input power source, the filter circuit and the rectifier circuit as shown in FIG. 1, the half-bridge electronic ballast having the DCM CP PFC circuit comprises a PFC stage (comprising a capacitor Cᵢₙ and a diode D_{y}), a half-bridge inverter (comprising an inductor Lₛ, two capacitors C_{B} and Cₚ, two switches S1-S2 and a lamp) and an output capacitor C_{dc}. However, the half-bridge electronic ballast having the DCM CP PFC circuit still has the following drawbacks:

(1) the circuit operating in DCM, such that the input current has a relatively larger di/dt, and the EMI is relatively more serious;

(2) the circuit having a relatively larger peak current, such that the circuit elements having a relatively larger withstand current must be used.

Due to that the half-bridge structure is not applicable in many medium and high power illumination applications, the present invention intends to combine the CCM CP PFC technique (see FIGS. 3 and 4) with the full-bridge electronic ballast. As shown in FIG. 3, the equivalent circuit of the CCM voltage-source CP PFC circuit has a rectified DC voltage source (supplying a rectified voltage |Vᵢₙ| and a current Iᵢₙ), two diodes Dₓ and D_{y}, an inductor L_{pfc}, a capacitor Cᵢₙ, a voltage source (supplying a voltage Vₐ), a load and an output capacitor C_{dc}, and a cross voltage of the output capacitor is an output voltage V_{bus}. As shown in FIG. 4, the equivalent circuit of the CCM current-source CP PFC circuit differs from FIG. 3 in that there is one diode Dₓ less, the rectified DC voltage source supplies a current I_{pfc}, the capacitor Cᵢₙ has a cross voltage V_{cin} and is electrically connected to the diode D_{y}, the voltage source Vₐ is replaced by a current-source (supplying a current Iₛ), and the output capacitor C_{dc} is replaced by an output voltage source (supplying a DC output voltage V_{bus}). As a result, not only the circuit structure and the elements of the driving circuit can be simplified, but also the volumes of the PFC inductor and the input filter circuit can be reduced via the CP PFC circuit so as to decrease the circuit costs and to shrink the volume of the circuit. Due to that the circuit operates in the CCM, thus to have a relatively lower input current harmonic distortion, the relatively higher input current power factor, the relatively lower diode conduction losses and switching losses, so as to raise the overall circuit efficiency.

Keeping the drawbacks of the prior arts in mind, and employing experiments and research full-heartily and persistently, the applicant finally conceived a full-bridge electronic ballast having a simplified continuous-conduction-mode charge pump PFC circuit.

### SUMMARY OF THE INVENTION

It is therefore an object of the present invention to provide a full-bridge electronic ballast having a simplified continuous-conduction-mode charge pump PFC circuit with the following advantages due to that the CP PFC technique is utilized: decreasing the required number of elements in the circuit so as to reducing the circuit costs, having low input current harmonic distortion and high power factor, decreasing the volumes of the elements such as PFC inductor and EMI filter, and decreasing the switching losses of a switch and the conduction losses of a diode.

According to the first aspect of the present invention, an electronic ballast comprises a filter circuit having a first and a second output terminals and receiving an AC input voltage, a rectifier circuit having a first input terminal, a second input terminal coupled to the second output terminal of the filter circuit, and a first output terminal, a continuous-conduction-mode charge pump PFC circuit comprising a first inductor having a first terminal coupled to the first input terminal of the rectifier circuit, and a second terminal coupled to the first output terminal of the filter circuit, a first diode having an anode and a cathode coupled to the first output terminal of the rectifier circuit, a second inductor having a first terminal, a first capacitor having a first terminal coupled to the first terminal of the first inductor and a second terminal coupled to the anode of the first diode and the first terminal of the second inductor, and a second diode having a cathode coupled to the first terminal of the second inductor, and a full-bridge inverter coupled to the continuous-conduction-mode charge pump PFC circuit and generating an AC output voltage.

According to the second aspect of the present invention, an electronic ballast comprises a rectifier circuit having a first input terminal and a second input terminal, a continuous-conduction-mode charge pump PFC circuit comprising a first inductor having a first terminal coupled to the first input terminal of the rectifier circuit, and a second terminal, a second inductor having a first terminal, and a first capacitor having a first terminal coupled to the first terminal of the first inductor and a second terminal coupled to the first terminal of the second inductor, and a full-bridge inverter coupled to the continuous-conduction-mode charge pump PFC circuit and generating an AC output voltage.

According to the third aspect of the present invention, an electronic ballast comprises a continuous-conduction-mode charge pump PFC circuit, and a full-bridge inverter coupled to the continuous-conduction-mode charge pump PFC circuit and generating an AC output voltage.

The present invention may best be understood through the following descriptions with reference to the accompanying drawings, in which:

### BRIEF DESCRIPTION OF THE DRAWINGS

FIG. 1 is a circuit diagram of a conventional two-stage electronic ballast in the prior art;

FIG. 2 is a circuit diagram of a half-bridge electronic ballast having a DCM CP PFC circuit in the prior art;

FIG. 3 is a circuit diagram of an equivalent circuit of a CCM voltage-source CP PFC circuit in the prior art;

FIG. 4 is a circuit diagram of an equivalent circuit of a CCM current-source CP PFC circuit in the prior art;

FIGS. 5-12(a) are respectively a circuit diagram of a full-bridge electronic ballast having a simplified CCM voltage-source CP PFC circuit according to the first to the eighth preferred embodiments of the present invention;

FIG. 12(b) is a simulation waveform diagram of the input voltage Vᵢₙ and the input current Iᵢₙ of a full-bridge electronic ballast having a simplified CCM voltage-source CP PFC circuit according to the eighth preferred embodiment of the present invention;

FIG. 13 is a circuit diagram of a full-bridge electronic ballast having a simplified CCM voltage-source CP PFC circuit according to the ninth preferred embodiment of the present invention; and

FIGS. 14-19 are respectively a circuit diagram of a full-bridge electronic ballast having a simplified CCM current-source CP PFC circuit according to the tenth to the fifteenth preferred embodiments.

### DETAILED DESCRIPTION OF THE PREFERRED EMBODIMENT

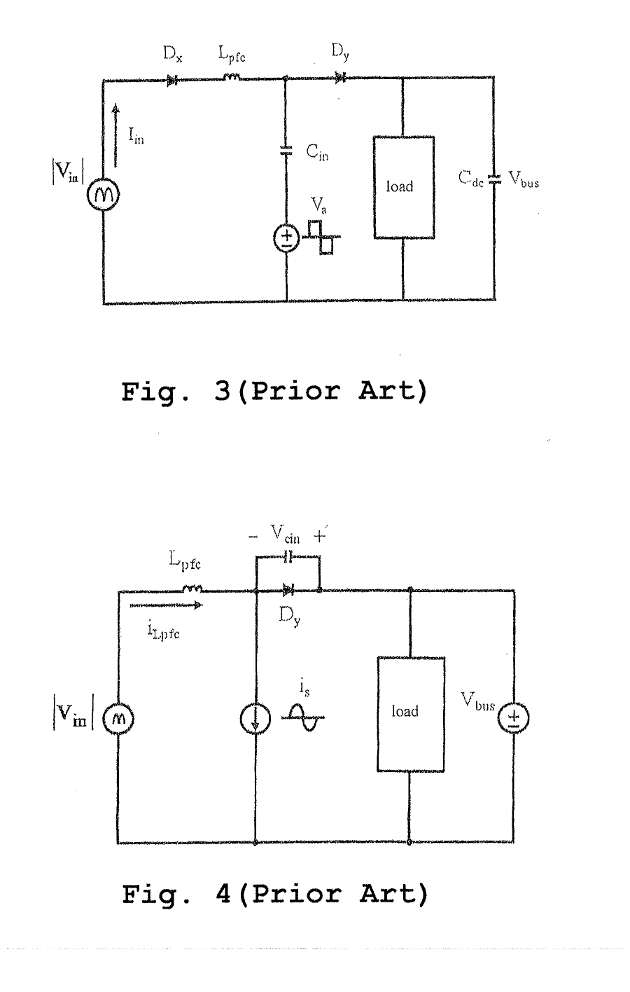

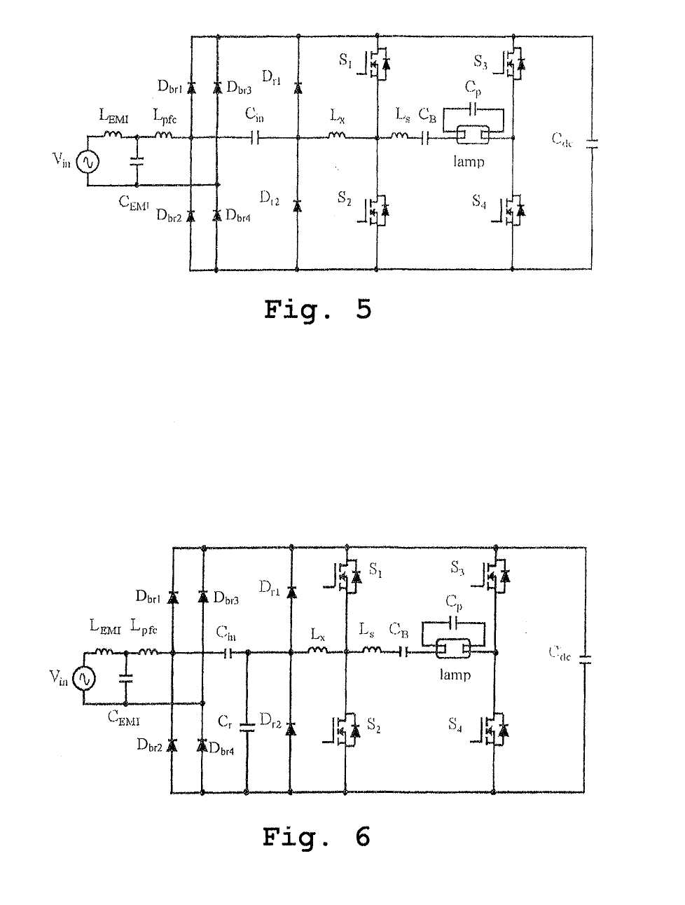

The present invention provides a CCM CP PFC circuit comprising the PFC inductor L_{pfc}, the CP capacitor Cᵢₙ, the equivalent diode D_{y} etc, which can be divided into the voltage-source type and the current-source type according to different circuit connection modes as shown in the aforementioned FIGS. 3 and 4, wherein the voltage-source type mainly connects a high frequency voltage-source in series to be a reference signal source, and the current-source type connects a high frequency current-source in parallel to be a reference signal source, both of which could achieve the effect of power factor correction.

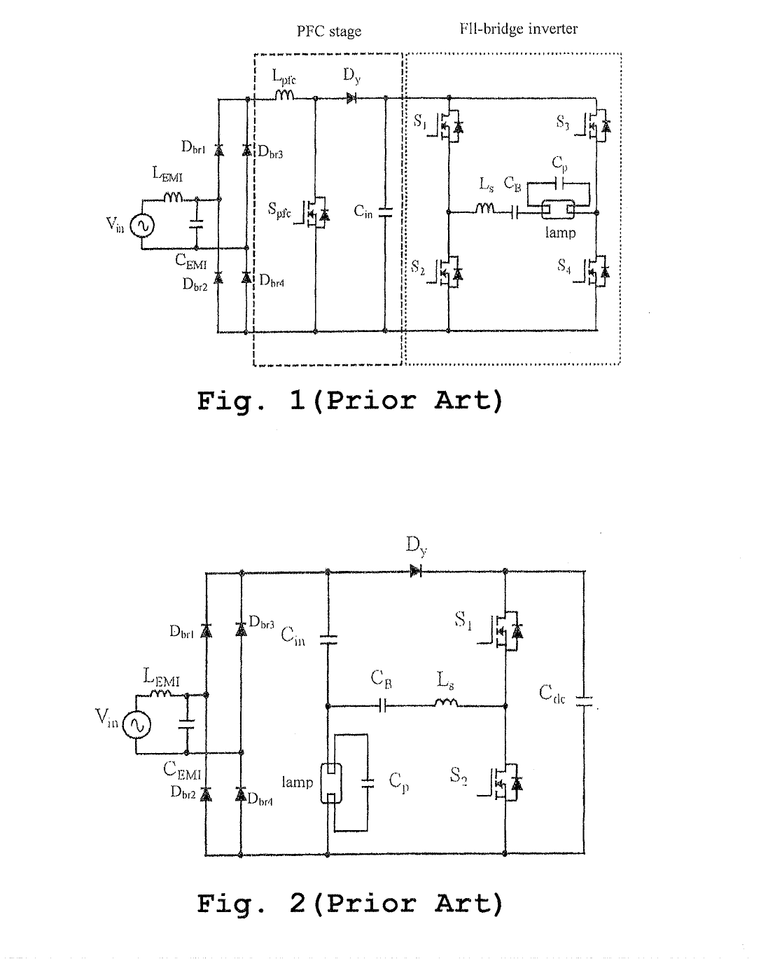

FIG. 5 is a circuit diagram of a full-bridge electronic ballast having a simplified continuous-conduction-mode charge pump PFC circuit according to the first preferred embodiment of the present invention. Except for the AC input power source, the filter circuit, the rectifier circuit and the full-bridge inverter as shown in FIG. 1 and the above-mentioned output capacitor C_{dc} as shown in FIG. 2, FIG. 5 differs from FIG. 1 in that the PFC stage in FIG. 1 is replaced by a simplified AC-side CCM CP PFC circuit, and the simplified AC-side CCM CP PFC circuit comprises a set of the CP PFC circuit: the inductor L_{pfc}/the rectifier diode D_{br1}/the capacitor Cᵢₙ/the diodes Dᵣ₁ and Dᵣ₂/the inductor Lₓ. In the aforementioned set of CP PFC circuit, the rectifier diode D_{br1} in the rectifier circuit is used to replace the originally used diode D_{y} (not shown), and the circuit is simplified since there is one diode less. In the electronic ballast as shown in FIG. 5, the first capacitor Cᵢₙ is directly connected to an end of the inductor L_{pfc}.

The preferred embodiments of the present invention, e.g., the full-bridge electronic ballast as shown in FIG. 5, utilize the aforementioned CP PFC technique to combine with the full-bridge electronic ballast to improve the power factor of which so as to obtain a lower harmonic distortion.

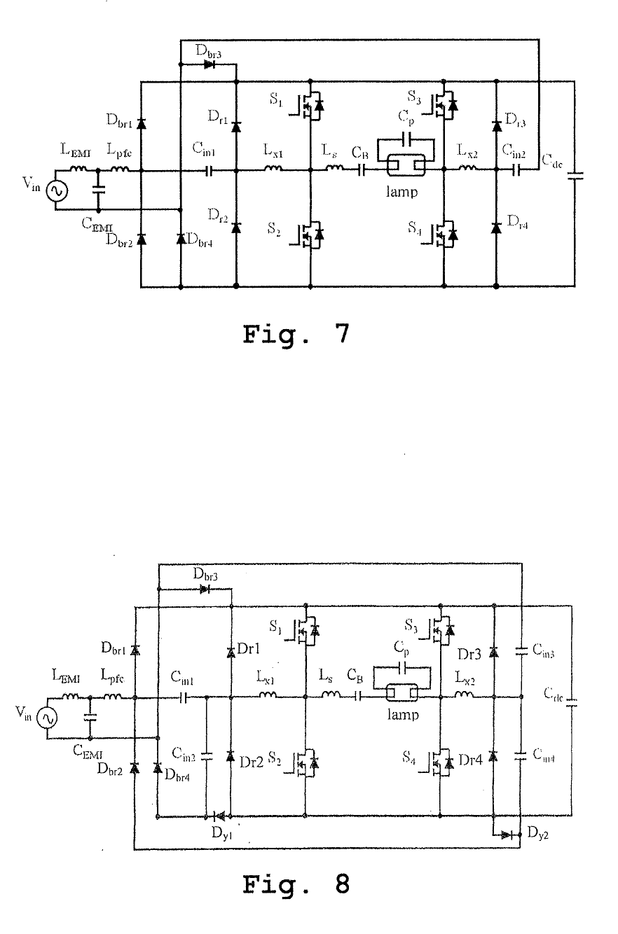

FIG. 6 is a circuit diagram of a full-bridge electronic ballast having a simplified continuous-conduction-mode charge pump PFC circuit according to the second preferred embodiment of the present invention. The electronic ballast as shown in FIG. 6 differs from the electronic ballast as shown in FIG. 5 mainly in that the electronic ballast in FIG. 6 further comprises a resonant tank comprising a resonant capacitor Cᵣ: Cᵣ/Lₓ.

FIG. 7 is a circuit diagram of a full-bridge electronic ballast having a simplified continuous-conduction-mode charge pump PFC circuit according to the third preferred embodiment of the present invention. The electronic ballast as shown in FIG. 7 differs from the electronic ballast as shown in FIG. 6 mainly in that the electronic ballast in FIG. 7 comprises two sets of CP PFC circuits: 1. the Inductor L_{pfc}/the rectifier diode D_{br1}/the capacitor Cᵢₙ₁/the diode Dᵣ₁/the inductor Lₓ₁ and 2. The inductor L_{pfc}/the rectifier diode D_{br3}/the capacitor Cᵢₙ₂/the clamping diode Dᵣ₂/the inductor Lₓ₂. In the above-mentioned two sets of CP PFC circuits, the rectifier diodes D_{br1} and D_{br3} are used to replace the two originally used diodes D_{y1} and D_{y2} (not shown), and the circuit is simplified since there are two diodes less.

FIG. 8 is a circuit diagram of a full-bridge electronic ballast having a simplified continuous-conduction-mode charge pump PFC circuit according to the fourth preferred embodiment of the present invention.

The electronic ballast as shown in FIG. 8 differs from the electronic ballast as shown in FIG. 7 in that the connection modes of the two clamping diodes Dᵣ₁ and Dᵣ₂ are different from those of FIG. 7.

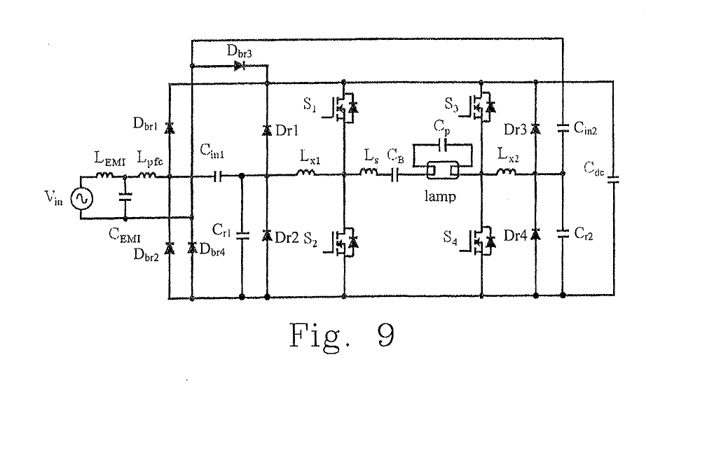

FIG. 9 is a circuit diagram of a full-bridge electronic ballast having a simplified continuous-conduction-mode charge pump PFC circuit according to the fifth preferred embodiment of the present invention. The electronic ballast as shown in FIG. 9 differs from the electronic ballasts as shown in FIGS. 7 and 8 mainly in that there are four clamping diodes Dᵣ₁-Dᵣ₄ in FIG. 9.

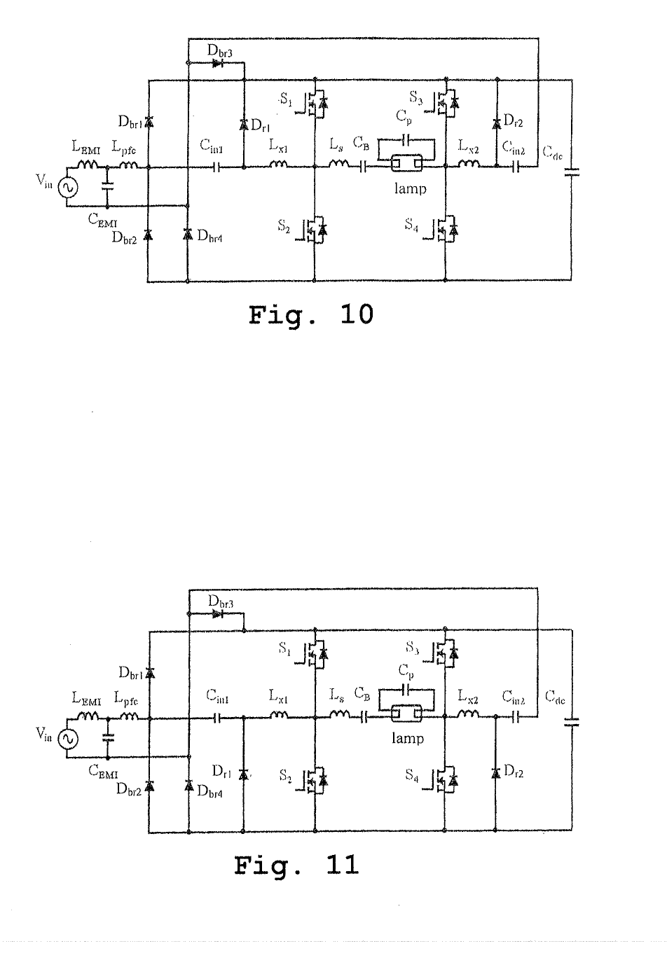

FIG. 10 is a circuit diagram of a full-bridge electronic ballast having a simplified continuous-conduction-mode charge pump PFC circuit according to the sixth preferred embodiment of the present invention. The electronic ballast as shown in FIG. 10 differs from the electronic ballast as shown in FIG. 9 mainly in that there are four sets of CP PFC circuit in FIG. 10:

L_{pfc}/D_{br1}/Cᵢₙ₁/Dᵣ₁/Lₓ₁, 1.

L_{pfc}/D_{y1}/Cᵢₙ₂/Dᵣ₂/Lₓ₁, 2.

L_{pfc}/D_{br3}/Cᵢₙ₃/Dᵣ₃/Lₓ₂, 3.

and

L_{pfc}/D_{y2}/Cᵢₙ₄/Dᵣ₄/Lₓ₂. 4.

In the above-mentioned four sets of CP PFC circuits, the rectifier diodes D_{br1} and D_{br3} are used to replace the two originally used diodes D_{y3} and D_{y3} (not shown) in the two specific sets of CP PFC circuits, and the circuit is simplified since there are two diodes less.

FIG. 11 is a circuit diagram of a full-bridge electronic ballast having a simplified continuous-conduction-mode charge pump PFC circuit according to the seventh preferred embodiment of the present invention. The electronic ballast as shown in FIG. 11 differs from the electronic ballast as shown in FIG. 10 mainly in that the equivalent diodes D_{y1}-D_{y4} (not shown) in the four sets of CP PFC circuit are replaced by the rectifier diodes Dᵣ₁-Dᵣ₄.

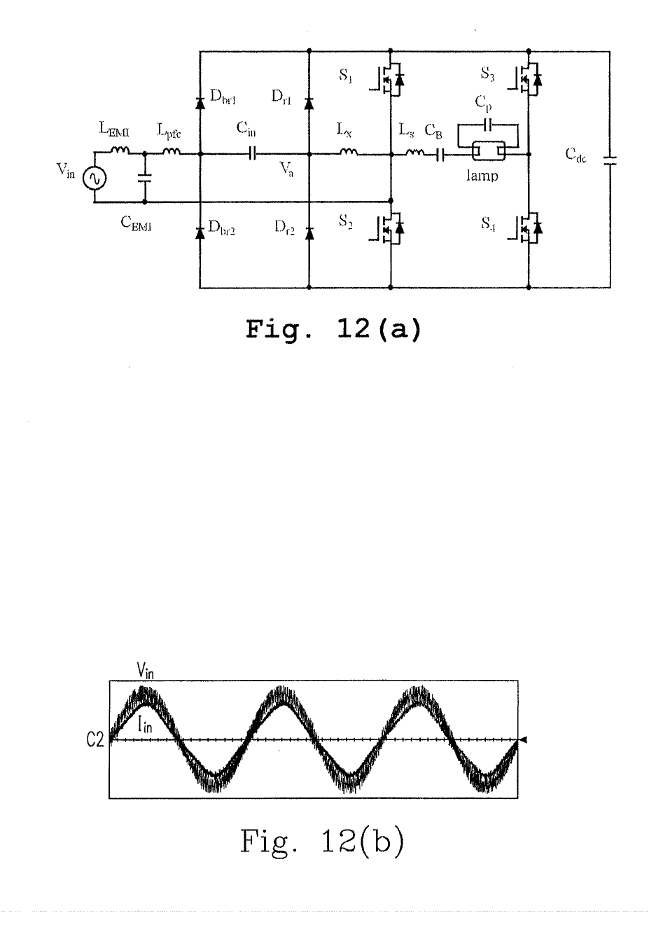

FIG. 12(a) is a circuit diagram of a full-bridge electronic ballast having a simplified continuous-conduction-mode charge pump PFC circuit according to the eighth preferred embodiment of the present invention. As shown in FIG. 12(a), the electronic ballast includes a filter circuit having a first and a second output terminals and receiving an AC input voltage, a rectifier circuit having a first input terminal, a second input terminal coupled to the second output terminal of the filter circuit, and a first output terminal, a continuous-conduction-mode charge pump PFC circuit comprising a first inductor L_{pfc} having a first terminal coupled to the first input terminal of the rectifier circuit and a second terminal coupled to the first output terminal of the filter circuit, a first diode Dᵣ₁ having an anode and a cathode coupled to the first output terminal of the rectifier circuit, a second inductor Lₓ having a first terminal, a first capacitor Cᵢₙ having a first terminal coupled to the first terminal of the first inductor L_{pfc} and a second terminal coupled to the anode of the first diode Dᵣ₁ and the first terminal of the second inductor Lₓ, and a second diode Dᵣ₂ having a cathode coupled to the first terminal of the second inductor Lₓ, and a full-bridge inverter coupled to the continuous-conduction-mode charge pump PFC circuit and generating an AC output voltage.

In FIG. 12(a), the electronic ballast further includes a second capacitor C_{dc}, wherein the rectifier circuit further comprises a second output terminal, the full-bridge inverter has a first and a second input terminals, a middle point, a first and a second output terminals and a bridge arm, the bridge arm includes a first switch S₁ coupled to the first input terminal of the full-bridge inverter and the middle point, and having a first bypass diode, and a second switch S₂ coupled to the middle point and the second input terminal of the full-bridge inverter, and having a second bypass diode, the continuous-conduction-mode charge pump PFC circuit further includes a third diode D_{br1} having an anode coupled to the first terminal of the first capacitor Cᵢₙ and a cathode coupled to the cathode of the first diode Dᵣ₁, the third diode D_{br1} is used to replace the equivalent diode D_{y} of the CP PFC circuit so as to simplified the circuit, the second inductor Lₓ has a second terminal coupled to the middle point of the full-bridge inverter, the cathode of the first diode Dᵣ₁ is coupled to the first input terminal of the full-bridge inverter, the second input terminal of the full-bridge inverter is coupled to the second output terminal of the rectifier circuit, the rectifier circuit comprises the third diode D_{br1}, the first bypass diode of the first switch, the second bypass diode of the second switch and a fourth diode Dbr2, the second diode Dᵣ₂ further comprises an anode coupled to the second input terminal of the full-bridge inverter, and the second capacitor C_{dc} is electrically connected to the first and the second output terminals of the full-bridge inverter in parallel. The second capacitor C_{dc} is an output capacitor, and the continuous-conduction-mode charge pump PFC circuit is a continuous-conduction-mode voltage-source charge pump PFC circuit.

FIG. 12(b) is a simulation waveform diagram of the input voltage Vᵢₙ and the input current Iᵢₙ of a full-bridge electronic ballast having a simplified continuous-conduction-mode charge pump PFC circuit according to the eighth preferred embodiment of the present invention.

Please refer to FIG. 12(a), the electronic ballast includes a filter circuit having a first and a second output terminals and receiving an AC input voltage, a rectifier circuit having a first input terminal and a second input terminal coupled to the second output terminal of the filter circuit, a continuous-conduction-mode charge pump PFC circuit comprising a first inductor having a first terminal coupled to the first input terminal of the rectifier circuit and a second terminal coupled to the first output terminal of the filter circuit, a second inductor having a first terminal, and a first capacitor having a first terminal coupled to the first terminal of the first inductor, and a second terminal coupled to the first terminal of the second inductor, and a full-bridge inverter coupled to the continuous-conduction-mode charge pump PFC circuit and generating an AC output voltage.

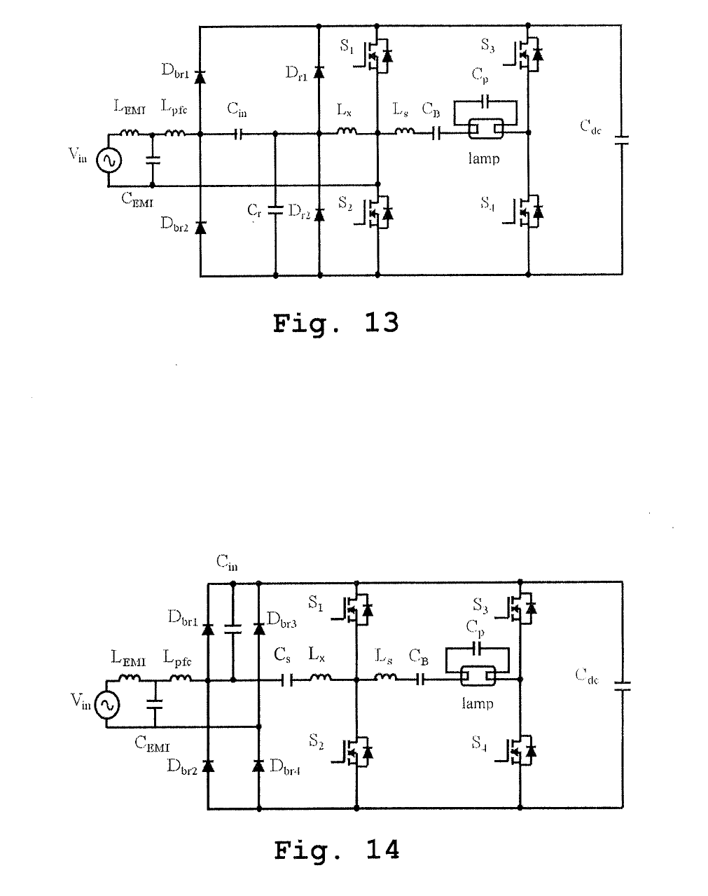

FIG. 13 is a circuit diagram of a full-bridge electronic ballast having a simplified continuous-conduction-mode charge pump PFC circuit according to the ninth preferred embodiment of the present invention. The electronic ballast as shown in FIG. 13 differs from the electronic ballast as shown in FIG. 12(a) mainly in that the CCM CP PFC circuit further comprises a third capacitor Cᵣ having a first terminal coupled to the first terminal of the second inductor Lₓ and a second terminal coupled to the anode of the second diode Dᵣ₂, and the third capacitor Cᵣ is a resonant capacitor formed a resonant tank with the second inductor Lₓ.

The unique features of the electronic ballasts respectively shown in FIGS. 12(a) and 13 can be generalized as the electronic ballast includes a filter circuit having a first and a second output terminals and receiving an AC input voltage, a rectifier circuit having a first input terminal and a second input terminal coupled to the second output terminal of the filter circuit, a CCM CP PFC circuit comprising a first inductor L_{pfc} having a first terminal coupled to the first input terminal of the rectifier circuit and a second terminal coupled to the first output terminal of the filter circuit, a second inductor Lₓ having a first terminal, and a first capacitor Cᵢₙ having a first terminal coupled to the first terminal of the first inductor L_{pfc} and a second terminal coupled to the first terminal of the second inductor Lₓ, and a full-bridge inverter coupled to the CCM CP PFC circuit and generating an AC output voltage.

The electronic ballasts respectively shown in FIGS. 12(a) and 13 further comprise a first and a second diodes Dᵣ₁ and Dᵣ₂, each of which comprises an anode and a cathode, wherein the rectifier circuit further comprises a first and a second output terminals, the cathode of the first diode is coupled to the first output terminal of the rectifier circuit, the anode of the first diode Dᵣ₁ is coupled to the second terminal of the first capacitor Cᵢₙ, the cathode of the second diode Dᵣ₂ is coupled to the first terminal of the second inductor Lₓ, and the anode of the second diode Dᵣ₂ is coupled to the second output terminal of the rectifier circuit.

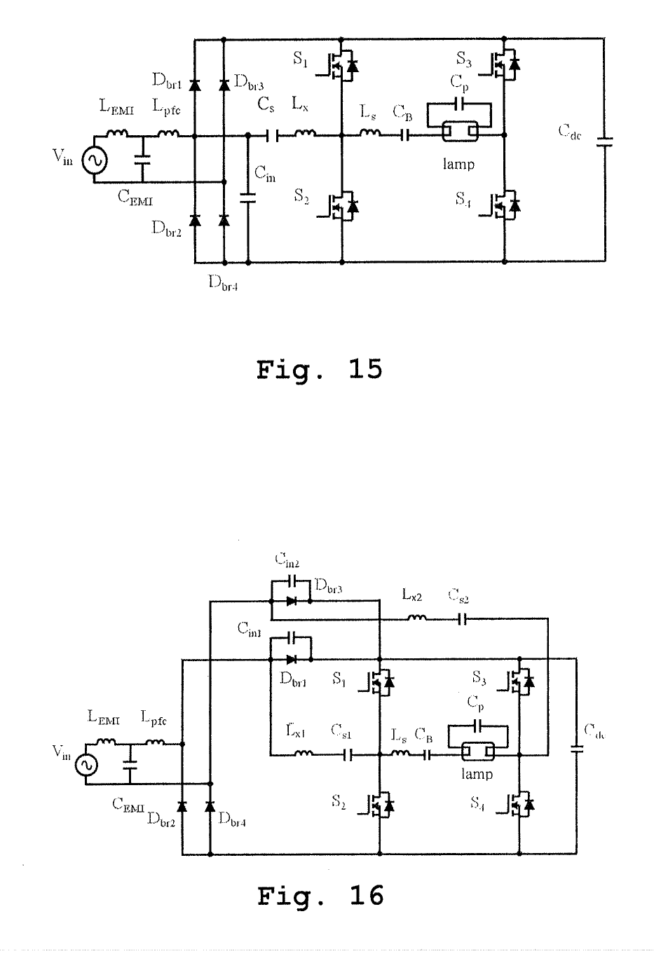

FIG. 14 is a circuit diagram of a full-bridge electronic ballast having a simplified continuous-conduction-mode charge pump PFC circuit according to the tenth preferred embodiment of the present invention. As shown in FIG. 14, the electronic ballast comprises a set of CP PFC circuit, L_{pfc}/D_{br1}/Cᵢₙ/Cₛ/Lₓ, wherein a diode D_{br1} of a rectifier circuit (comprising rectifier diodes D_{br1}-D_{br4}) is used to replace the equivalent diode D_{y} (not shown) of the set of CP PFC circuit so as to simplified the circuit of the ballast.

FIG. 15 is a circuit diagram of a full-bridge electronic ballast having a simplified continuous-conduction-mode charge pump PFC circuit according to the eleventh preferred embodiment of the present invention. The electronic ballast as shown in FIG. 15 differs from the electronic ballast as shown in FIG. 14 mainly in that the connection mode of the capacitor Cᵢₙ is different from that of FIG. 14.

FIG. 16 is a circuit diagram of a full-bridge electronic ballast having a simplified continuous-conduction-mode charge pump PFC circuit according to the twelfth preferred embodiment of the present invention, in which there are two sets of CP PFC circuits: L_{pfc}/D_{br1}/Cᵢₙ₁/Lₓ₁/Cₛ₁ and L_{pfc}/D_{br2}/Cᵢₙ₂/Lₓ₂/Cₛ₂. Two diodes D_{br1} and D_{br3} of a rectifier circuit comprising rectifier diodes D_{br1}-D_{br4} are used to replace the equivalent diodes D_{y1}/D_{y2} (not shown) of the two sets of CP PFC circuits so as to simplified the circuit of the electronic ballast.

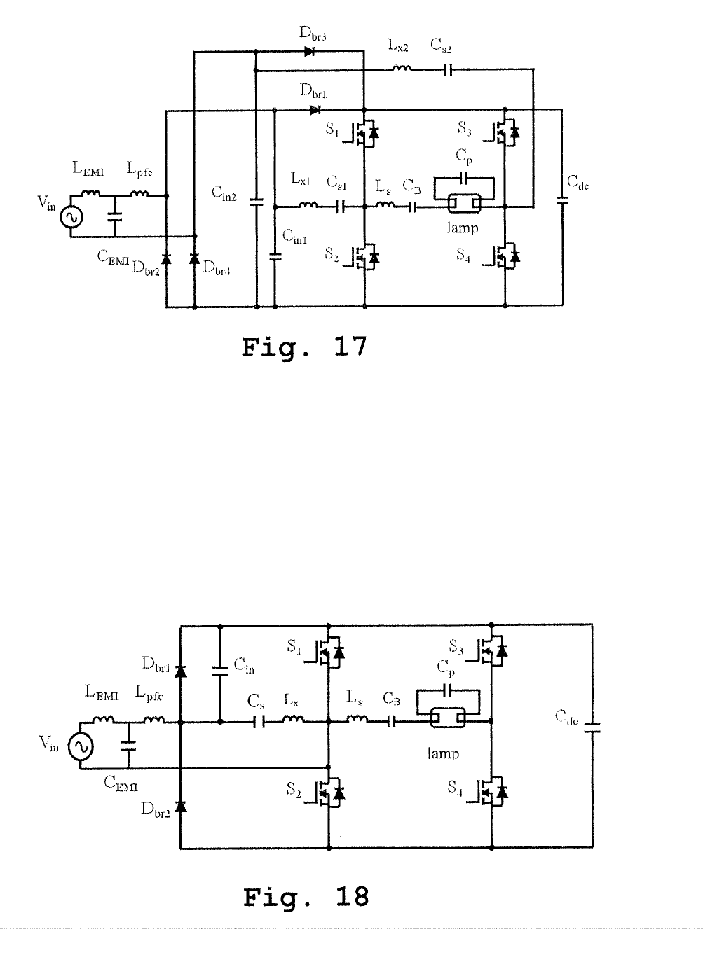

FIG. 17 is a circuit diagram of a full-bridge electronic ballast having a simplified continuous-conduction-mode charge pump PFC circuit according to the thirteen preferred embodiment of the present invention. The electronic ballast as shown in FIG. 17 differs from the electronic ballast as shown in FIG. 16 mainly in that the connection modes of the two capacitors Cᵢₙ₁ and Cᵢₙ₁ are different from those of FIG. 16.

FIG. 18 is a circuit diagram of a full-bridge electronic ballast having a simplified continuous-conduction-mode charge pump PFC circuit according to the fourteenth preferred embodiment of the present invention. Referring to the electronic ballast as shown in FIG. 18, it includes a filter circuit having a first and a second output terminals and receiving an AC input voltage, a rectifier circuit having a first input terminal and a second input terminal coupled to the second output terminal of the filter circuit, a continuous-conduction-mode charge pump PFC circuit comprising a first inductor L_{pfc} having a first terminal coupled to the first input terminal of the rectifier circuit and a second terminal coupled to the first output terminal of the filter circuit, a first capacitor Cᵢₙ having a first terminal, a second capacitor Cₛ having a first terminal coupled to the first terminal of the first capacitor Cᵢₙ, and a second terminal, and a second inductor Lₓ having a first terminal coupled to the second terminal of the second capacitor Cₛ, and a full-bridge inverter coupled to the continuous-conduction-mode charge pump PFC circuit and generating an AC output voltage.

Please refer to the electronic ballast as shown in FIG. 18, wherein the rectifier circuit includes the diode D_{br1}, the bypass diode of the first switch S₁, the bypass diode of the second switch S₂ and the diode D_{br2}, the diode D_{br1} is used to replace the diode D_{y} (not shown) of the CP PFC circuit so as to simplified the circuit. The first capacitor Cᵢₙ further comprises a second terminal coupled to the first output terminal of the rectifier circuit, and the continuous-conduction-mode charge pump PFC circuit is a continuous-conduction-mode current-source charge pump PFC circuit.

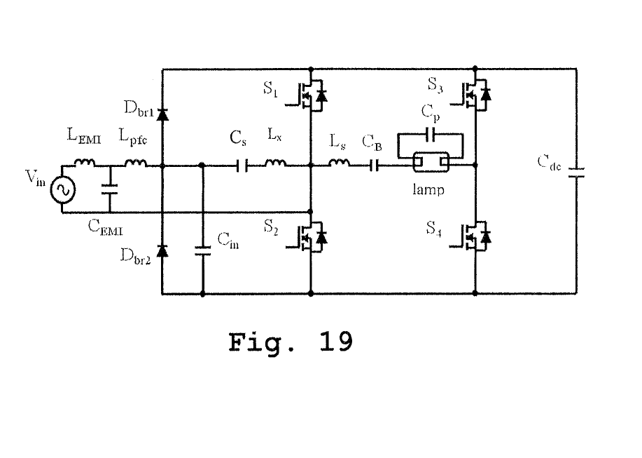

FIG. 19 is a circuit diagram of a full-bridge electronic ballast having a simplified continuous-conduction-mode charge pump PFC circuit according to the fifteenth preferred embodiment of the present invention. The electronic ballast as shown in FIG. 19 differs from the electronic ballast as shown in FIG. 18 mainly in that the connection mode of the capacitor Cᵢₙ is different from that of FIG. 18. In FIG. 19, the second terminal of the first capacitor Cᵢₙ is coupled to the second output terminal of the rectifier circuit.

In the above-mentioned preferred embodiments as shown in FIGS. 5-19, the usage of the series connected inductors Lx/Lx1/Lx2 is to decrease the inrush current caused by the dramatically variances of the cross voltages of the CP capacitors Cin/Cin1/Cin2 momentarily after the switch is turned on. Besides, the series connected inductor Lx/Lx1/Lx2 also possesses the functions of storing the energy therein and then transferring the energy to the load side. In FIG. 13, the additionally added set of series connected LC resonant tank (Cᵣ/Lₓ) is used to provide a high frequency voltage source as a reference to the CP capacitor Cᵢₙ. Each of the diodes in the Dr series (comprising Dr1-Dr2 or Dr1-Dr4) is a clamping diode, and is mainly used when the switch is cut off, the current on the inductor tends to maintain an afterflow, a path for energy release is provided via these clamping diodes, the mutually resonant time with the CP capacitors Cin/Cin1/Cin2 can be decreased, and thus it has the function of reducing the voltage stress of the switch.

### EMBODIMENTS

1. An electronic ballast, comprising:

a filter circuit having a first and a second output terminals and receiving an AC input voltage;

a rectifier circuit having a first input terminal, a second input terminal coupled to the second output terminal of the filter circuit, and a first output terminal;

a continuous-conduction-mode charge pump PFC circuit, comprising:

a first inductor having a first terminal coupled to the first input terminal of the rectifier circuit, and a second terminal coupled to the first output terminal of the filter circuit;

a first diode having an anode and a cathode coupled to the first output terminal of the rectifier circuit;

a second inductor having a first terminal;

a first capacitor having a first terminal coupled to the first terminal of the first inductor and a second terminal coupled to the anode of the first diode and the first terminal of the second inductor; and

a second diode having a cathode coupled to the first terminal of the second inductor; and

a full-bridge inverter coupled to the continuous-conduction-mode charge pump PFC circuit and generating an AC output voltage.

2. An electronic ballast according to embodiment 1 further comprising a second capacitor, wherein the rectifier circuit further comprises a second output terminal, the full-bridge inverter has a first and a second input terminals, a middle point, a first and a second output terminals and a bridge arm, the bridge arm includes a first switch and a second switch, the first switch of the bridge arm is coupled to the first input terminal of the full-bridge inverter and the middle point and has a first bypass diode, the second switch of the bridge arm is coupled to the middle point and the second input terminal of the full-bridge inverter and has a second bypass diode, the continuous-conduction-mode charge pump PFC circuit further includes a third diode having an anode coupled to the first terminal of the first capacitor and a cathode coupled to the cathode of the first diode, the second inductor has a second terminal coupled to the middle point of the full-bridge inverter, the cathode of the first diode is coupled to the first input terminal of the full-bridge inverter, the second input terminal of the full-bridge inverter is coupled to the second output terminal of the rectifier circuit, the rectifier circuit comprises the third diode, the first bypass diode of the first switch, the second bypass diode of the second switch and a fourth diode, the second diode further comprises an anode coupled to the second input terminal of the full-bridge inverter, and the second capacitor is electrically connected to the first and the second output terminals of the full-bridge inverter in parallel.

3. An electronic ballast according to embodiment 1 or 2, wherein the second capacitor is an output capacitor, and the continuous-conduction-mode charge pump PFC circuit is a continuous-conduction-mode voltage-source charge pump PFC circuit.

4. An electronic ballast according to any one of embodiments 1 to 3, wherein the continuous-conduction-mode charge pump PFC circuit further comprises a third capacitor having a first terminal coupled to the first terminal of the second inductor, and a second terminal coupled to the anode of the second diode.

5. An electronic ballast, comprising:

a rectifier circuit having a first input terminal and a second input terminal;

a continuous-conduction-mode charge pump PFC circuit, comprising:

a first inductor having a first terminal coupled to the first input terminal of the rectifier circuit, and a second terminal;

a second inductor having a first terminal; and

a first capacitor having a first terminal coupled to the first terminal of the first inductor and a second terminal coupled to the first terminal of the second inductor; and

a full-bridge inverter coupled to the continuous-conduction-mode charge pump PFC circuit and generating an AC output voltage.

6. An electronic ballast according to embodiment 5 further comprising a filter circuit having a first and a second output terminals and receiving an AC input voltage, wherein the second input terminal of the rectifier circuit is coupled to the second output terminal of the filter circuit and the second terminal of the first inductor is coupled to the first output terminal of the filter circuit.

7. An electronic ballast according to embodiment 5 or 6 further comprising a first and a second diodes, each of which comprises an anode and a cathode, wherein the rectifier circuit further comprises a first and a second output terminals, the cathode of the first diode is coupled to the first output terminal of the rectifier circuit, the anode of the first diode is coupled to the second terminal of the first capacitor, the cathode of the second diode is coupled to the first terminal of the second inductor, and the anode of the second diode is coupled to the second output terminal of the rectifier circuit.

8. An electronic ballast according to any one of embodiments 5 to 7, wherein the full-bridge inverter has a first and a second input terminals and a middle point, the second inductor has a second terminal coupled to the middle point, the cathode of the first diode is coupled to the first input terminal of the full-bridge inverter, and the second input terminal of the full-bridge inverter is coupled to the second output terminal of the rectifier circuit.

9. An electronic ballast, comprising:

a continuous-conduction-mode charge pump PFC circuit; and

a full-bridge inverter coupled to the continuous-conduction-mode charge pump PFC circuit and generating an AC output voltage.

10. An electronic ballast according to embodiment 9, wherein the continuous-conduction-mode charge pump PFC circuit further comprises a first inductor and a second inductor.

11. An electronic ballast according to embodiment 9 or 10 further comprising a rectifier circuit having a first input terminal and a second input terminal, wherein the continuous-conduction-mode charge pump PFC circuit further comprises a first capacitor and a second capacitor, the first inductor has a first terminal coupled to the first input terminal of the rectifier circuit and has a second terminal coupled to the first output terminal of the filter circuit, the first capacitor has a first terminal, the second capacitor has a first terminal coupled to the first terminal of the first capacitor and has a second terminal, and the second inductor has a first terminal coupled to the second terminal of the second capacitor.

12. An electronic ballast according to any one of embodiments 9-11 further comprising a filter circuit having a first and a second output terminals and receiving an AC input voltage, wherein the second input terminal of the rectifier circuit is coupled to the second output terminal of the filter circuit and the second terminal of the first inductor is coupled to the first output terminal of the filter circuit.

13. An electronic ballast according to any one of embodiments 9-12, wherein the rectifier circuit further has a first output terminal, the first capacitor further has a second terminal coupled to the first output terminal of the rectifier circuit, and the continuous-conduction-mode charge pump PFC circuit is a continuous-conduction-mode current-source charge pump PFC circuit.

14. An electronic ballast according to any one of embodiments 9-13, wherein the rectifier circuit further has a first and a second output terminals, and the first capacitor further has a second terminal coupled to the second output terminal of the rectifier circuit.

According to the aforementioned descriptions, the present invention provides a full-bridge electronic ballast having a simplified continuous-conduction-mode charge pump PFC circuit with the following advantages due to that the CP PFC technique is utilized: decreasing the required number of elements in the circuit so as to reduce the circuit costs, having low input current harmonic distortion and high power factor, decreasing the volumes of the elements such as PFC inductor and EMI filter, and decreasing the switching losses of a switch and the conduction losses of a diode so as to possess the non-obviousness and the novelty.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present invention which is defined by the appended claims.

What is claimed is:

1. An electronic ballast, comprising:
a filter circuit having a first and a second output terminals and receiving an AC input voltage;
a rectifier circuit having a first input terminal, a second input terminal coupled to the second output terminal of the filter circuit, and a first output terminal;
a continuous-conduction-mode charge pump PFC circuit, comprising:
a first inductor having a first terminal coupled to the first input terminal of the rectifier circuit, and a second terminal coupled to the first output terminal of the filter circuit;
a first diode having an anode and a cathode coupled to the first output terminal of the rectifier circuit;
a second inductor having a first terminal;
a first capacitor having a first terminal coupled to the first terminal of the first inductor and a second terminal coupled to the anode of the first diode and the first terminal of the second inductor; and
a second diode having a cathode coupled to the first terminal of the second inductor; and
a full-bridge inverter coupled to the continuous-conduction-mode charge pump PFC circuit and generating an AC output voltage.

2. An electronic ballast according to claim 1 further comprising a second capacitor, wherein the rectifier circuit further comprises a second output terminal, the full-bridge inverter has a first and a second input terminals, a middle point, a first and a second output terminals and a bridge arm, the bridge arm includes a first switch and a second switch, the first switch of the bridge arm is coupled to the first input terminal of the full-bridge inverter and the middle point and has a first bypass diode, the second switch of the bridge arm is coupled to the middle point and the second input terminal of the full-bridge inverter and has a second bypass diode, the continuous-conduction-mode charge pump PFC circuit further includes a third diode having an anode coupled to the first terminal of the first capacitor and a cathode coupled to the cathode of the first diode, the second inductor has a second terminal coupled to the middle point of the full-bridge inverter, the cathode of the first diode is coupled to the first input terminal of the full-bridge inverter, the second input terminal of the full-bridge inverter is coupled to the second output terminal of the rectifier circuit, the rectifier circuit comprises the third diode, the first bypass diode of the first switch, the second bypass diode of the second switch and a fourth diode, the second diode further comprises an anode coupled to the second input terminal of the full-bridge inverter, and the second capacitor is electrically connected to the first and the second output terminals of the full-bridge inverter in parallel.

3. An electronic ballast according to claim 2, wherein the second capacitor is an output capacitor, and the continuous-conduction-mode charge pump PFC circuit is a continuous-conduction-mode voltage-source charge pump PFC circuit.

4. An electronic ballast according to claim 2, wherein the continuous-conduction-mode charge pump PFC circuit further comprises a third capacitor having a first terminal coupled to the first terminal of the second inductor, and a second terminal coupled to the anode of the second diode.

5. An electronic ballast, comprising:
a rectifier circuit having a first input terminal and a second input terminal;
a continuous-conduction-mode charge pump PFC circuit, comprising:
a first inductor having a first terminal coupled to the first input terminal of the rectifier circuit, and a second terminal;
a second inductor having a first terminal; and
a first capacitor having a first terminal coupled to the first terminal of the first inductor and a second terminal coupled to the first terminal of the second inductor; and
a full-bridge inverter coupled to the continuous-conduction-mode charge pump PFC circuit and generating an AC output voltage.

6. An electronic ballast according to claim 5 further comprising a filter circuit having a first and a second output terminals and receiving an AC input voltage, wherein the second input terminal of the rectifier circuit is coupled to the second output terminal of the filter circuit and the second terminal of the first inductor is coupled to the first output terminal of the filter circuit.

7. An electronic ballast according to claim 5 further comprising a first and a second diodes, each of which comprises an anode and a cathode, wherein the rectifier circuit further comprises a first and a second output terminals, the cathode of the first diode is coupled to the first output terminal of the rectifier circuit, the anode of the first diode is coupled to the second terminal of the first capacitor, the cathode of the second diode is coupled to the first terminal of the second inductor, and the anode of the second diode is coupled to the second output terminal of the rectifier circuit.

8. An electronic ballast according to claim 7, wherein the full-bridge inverter has a first and a second input terminals and a middle point, the second inductor has a second terminal coupled to the middle point, the cathode of the first diode is coupled to the first input terminal of the full-bridge inverter, and the second input terminal of the full-bridge inverter is coupled to the second output terminal of the rectifier circuit.

9. An electronic ballast, comprising:
a continuous-conduction-mode charge pump PFC circuit; and
a full-bridge inverter coupled to the continuous-conduction-mode charge pump PFC circuit and generating an AC output voltage.

10. An electronic ballast according to claim 9, wherein the continuous-conduction-mode charge pump PFC circuit further comprises a first inductor and a second inductor.

11. An electronic ballast according to claim 10 further comprising a rectifier circuit having a first input terminal and a second input terminal, wherein the continuous-conduction-mode charge pump PFC circuit further comprises a first capacitor and a second capacitor, the first inductor has a first terminal coupled to the first input terminal of the rectifier circuit and has a second terminal coupled to the first output terminal of the filter circuit, the first capacitor has a first terminal, the second capacitor has a first terminal coupled to the first terminal of the first capacitor and has a second terminal, and the second inductor has a first terminal coupled to the second terminal of the second capacitor.

12. An electronic ballast according to claim 10 further comprising a filter circuit having a first and a second output terminals and receiving an AC input voltage, wherein the second input terminal of the rectifier circuit is coupled to the second output terminal of the filter circuit and the second terminal of the first inductor is coupled to the first output terminal of the filter circuit.

13. An electronic ballast according to claim 10, wherein the rectifier circuit further has a first output terminal, the first capacitor further has a second terminal coupled to the first output terminal of the rectifier circuit, and the continuous-conduction-mode charge pump PFC circuit is a continuous-conduction-mode current-source charge pump PFC circuit.

14. An electronic ballast according to claim 10, wherein the rectifier circuit further has a first and a second output terminals, and the first capacitor further has a second terminal coupled to the second output terminal of the rectifier circuit.
